(19) United States
(12) Patent Application Publication
(10) Pub. No.: US 2023/0067699 A1
(43) Pub. Date: Mar. 2, 2023

(54) Optoelectronic sensor and method of detecting objects in a monitored zone

(71) Applicant: SICK AG, Waldkirch (DE)

(72) Inventors: Christoph MENZEL, Waldkirch (DE); Siegfried RINGWALD, Waldkirch (DE); Kai WASLOWSKI, Waldkirch (DE)

(21) Appl. No.: 17/823,228

(22) Filed: Aug. 30, 2022

(30) Foreign Application Priority Data
Aug. 31, 2021 (DE) 102021122418.7

(51) Int. Cl. G01S 17/04; G01S 7/481; G01S 17/08

(52) U.S. Cl. CPC G01S 17/04; G01S 7/4816; G01S 17/08

(57) ABSTRACT

An optoelectronic sensor for detecting an object in a monitored zone is provided that has a light transmitter and a transmission optics associated with the light transmitter in a transmission path for transmitting a light beam and a light receiver and a reception optics associated with the light receiver and offset from the transmission optics by a spacing in a reception path for receiving a light beam remitted by the object and for generating a received light spot on the light receiver, as well a control and evaluation unit that is configured to evaluate a received signal of the light receiver. The reception optics has at least one optical metaelement having a metasurface and/or a metamaterial and is configured such that a displacement of the received light spot on the light receiver in a near zone of the sensor dependent on a distance of the object from the sensor is no larger than a full width at half maximum of the received light spot.

The invention relates to an optoelectronic sensor and to a method of detecting objects in a monitored zone respectively.

As a rule, optoelectronic sensors use a receiver lens to focus the light to be detected on their light receiver. Such receiver lenses have a certain construction size and focal length and a defined distance between the receiver lens and the light receiver results from this.

To achieve large ranges with a sensor, as much useful light as possible should be collected and the reception aperture should therefore be large. A large reception opening is, however, necessarily also accompanied by a large construction depth. It can approximately be assumed that the diameter of the reception aperture corresponds to the required construction depth for the reception lens and the light receiver. A reception optics having a short focal length can be used to reduce the construction depth.

With sensors in which the optical axes of the transmission and reception optics do not run coaxially, that is with sensors having pupil division, also called biaxial sensors, a migration of the received light spot out of the active zone of the light receiver can occur due to the parallax induced by the spacing of the transmission and reception optics. This in particular applies with a working zone having a large distance of near and far zones.

Finally, the received light energy or the reception level also reduces approximately quadratically with the object distance. The measurement is therefore very sensitive in the near zone and very insensitive in the far zone.

The described effects are typically at least partially reduced in that complex optics having a plurality of part zones or composite optics can be used. EP 0 924 535 B1, EP 3 018 495 B1 or EP 3 002 609 B1 of the applicant disclose such solutions, for example. Transmission and reception optics such as described in EP 0 735 501 B1, for example, can also be arranged coaxially, with a partially permeable deflection mirror being required to make the transmission axis congruent with the reception axis. An additional construction space demand of lenses or mirrors thereby results. Both solutions are therefore technically complex.

The paper by Reshef, Orad, et al. “An optic to replace space and its application towards ultra-thin imaging systems”, Nature communications 12.1 (2021): 1-8 looks at so-called metalenses and spaceplates without any connection to biaxial optoelectronic sensors. Metalenses are extremely thin optical elements having a lens effect that have special nanostructures to influence beam paths. Spaceplates in turn are directed with similar technologies to the region between the lenses since a plurality of metalenses also first have to observe a distance from one another like classical lenses. The spaceplates should reduce this distance to be able to further reduce the construction depth of an optics.

It is therefore the object of the invention to further improve an optoelectronic sensor for detecting an object in a monitored zone.

This object is satisfied by an optoelectronic sensor for detecting an object in a monitored zone and by a method of detecting an object in a monitored zone in accordance with the respective independent claim.

The sensor, for example a light sensor or a distance measurement device in accordance with the principle of the time of flight (TOF sensor), has a transmission path in which a light transmitter transmits a light beam via a transmission optics and a reception path in which the light beam remitted at an object is imaged via a reception optics on a light receiver and generates a received light spot there that is detected by the light receiver. The remitted light beam can be produced both by diffuse remission and by directed reflection. The reception optics and the transmission optics are offset from one another by a distance, for example measured between the optical axes of the reception optics and the transmission optics.

A position of incidence of the received light spot that the remitted light beam generates on the light receiver is dependent on the distance of the object from the sensor due to the spacing of the reception optics and the transmission optics. Since the received light spot is as a rule not a spot with defined margins and has an extent, the position of a focus of an intensity distribution of the received light spot is to be understood as the position of the received light spot in the following. As the distance changes, the received light spot is laterally displaced, that is perpendicular to the reception path or perpendicular to an optical axis of the reception optics. While this effect is used for a distance determination of objects in triangulation sensors, it can considerably influence the measurement precision and the sensitivity in other sensors. The received light spot can in particular migrate from the light sensitive region of the light receiver when the object is too close to the sensor.

The invention starts from the basic idea of providing an optical metaelement in the reception path. The metaelement acts differently on the remitted light beam in dependence on the embodiment and replaces and/or supplements the reception optics. The metaelement for this purpose has a metasurface and/or a metal material, i.e. nanostructures, that form certain wavefronts of the remitted light beam in a very targeted manner. Such nanostructures are provided at the surface with a metasurface; a metamaterial achieves corresponding properties through the nanostructure of a layer system or of a solid body.

The invention has the advantage that the initially described disadvantages of an optoelectronic sensor can be considerably improved. This relates to a plurality of sensor properties that are addressed in part or in full. The dependence of the position of incidence of the received light spot on the light receiver on the distance of the object is reduced over a large distance range by an improved reception optics such that a distance dependent displacement of a position of the received light spot on the light receiver, in particular toward a center of a light sensitive surface of the light receiver, is no larger than a full width at half maximum of the received light spot in the near zone, with the width of the received light spot in the direction of displacement, in which the intensity of the received light spot has dropped to half of its maximum, having to be understood as the full width at half maximum.

This results in an improvement of the measurement precision and the sensitivity over the near and far zones. As mentioned above, the received light spot can in particular migrate out of the active zone of the light receiver in the near zone when the object is too close to the sensor, which is prevented by the reception optics in accordance with the invention.

The reception optics can preferably be configured such that the distance dependent displacement of a position of the received light spot on the light receiver, in particular toward a center of a light sensitive surface of the light receiver, is no longer than half the full width at half maximum of the received light spot in the near zone.

The reception optics can also be configured such that the position of the received light spot on the light receiver has no displacement dependent on the distance of the object within usual tolerances.

The optical metaelement can preferably have a metalens. In this respect, a metasurface is arranged at the front and/or rear sides on a flat, light-permeable carrier material. The nanostructure of the metasurface is configured such that the remitted light beam is shaped under desired lens properties, that is a typically spherical or parabolic phase profile is imparted on the remitted light beam. A metalens can have a metamaterial instead of a simple carrier material.

The optical metaelement can preferably have a spaceplate. A spaceplate is an example of a metamaterial, with it not primarily being applied to a change of the wavefront corresponding to a lens effect. A longer light path should rather so-to-say be implemented on a smaller physical space to be able to arrange optical elements, in particular metalenses, closer to one another. A spaceplate or another metamaterial can be provided with a metasurface at the front and/or rear sides to combine the effects of a spaceplate and of a metalens. Reference is additionally made to the paper named in the introduction of Reshef et al. for further details on spaceplates.

The optical metaelement can preferably at least partly have the function of the reception optics. This function is preferably to guide the remitted light beam onto the light receiver, and indeed such that the dependence of the position of incidence of the received light spot on the light receiver on the distance of the object is reduced over a large distance zone such that a displacement of the received light spot toward the center of an active surface of the light receiver is no larger than a full width at half maximum, particularly preferably no larger than half the full width at half maximum, of the received light spot. The range of the light receiver is to be understood as the active surface of the light receiver in which the received light spot can generate a measured signal that is available for further signal processing. With one-dimensional light receivers such as a photodiode or an avalanche photodiode (APD), this is the light sensitive surface of the light receiver. With two-dimensional matrix detectors (arrays), for example a single photon avalanche diode matrix (SPAD array), the active surface can also only comprise the individual elements or element groups (region of interest, ROI) of the array that are read by evaluation electronics of the array (activated individual elements or pixels).

The term “at least partly” can be understood in a double sense: there can both be further optical elements, in particular refractive and/or diffractive elements of the reception optics and the metaelement can take over further functions beyond those of the reception optics. The reception optics is preferably completely replaced, that is no further optical elements such as lenses and the like of the reception optics are required.

The reception optics can preferably have an optical corrective element that very largely, eliminates a dependence of a reception level or of a received light energy on the distance of the object from the sensor. The optical correction element can serve the purpose of at least coming closer to such an ideal situation. At least two interference effects to be minimized can be named for this purpose. First, the position of incidence in the near zone varies a great deal with changes of the object distance, but hardly at all in the far zone. In the near zone, an increasing portion thus misses the light receiver, which provides a smaller reception level. Second the reception level in the near zone is overmodulate and too weak in the far zone. A substantially constant reception level over the reception range would be desirable here. The optical corrective element can, for example, increase the received light spot as the object distance decreases so that the reception level or the received light energy is substantially independent of the object distance.

As will be seen for the first time at once and multiple times in the following, the optical corrective element does not have to be a separate additional component in accordance with the invention.

The optical metaelement can preferably have at least partly the function of the optical corrective element. The just explained reduction of the distance dependence of the reception level then does not take place by a refractive corrective lens or the like, but rather by the optical metaelement. The term “at least partly” again has the possible double meaning that there can be further optical elements for a reduction of the distance dependence of the reception level of the light receiver and/or the optical metaelement can take over further functions.

The optical metaelement can preferably have a focal length that varies with the angle of incidence, in particular monotonically. The nanostructures of the optical metaelement are sensibly not described structurally, but functionally. In practice, it is not a question of which specific nanostructure is provided, but rather that the desired optical properties are achieved. There are also the most varied different implementation possibilities here, that is nanostructures that equally satisfy a desired optical effect. The angle of incidence corresponds to the object distance due to the spacing of the transmission and reception paths. A classical lens would only have a uniform focal length for the incident remitted light beam, which then, however, produces the discussed interference effects. A focal length that varies with the angle of incidence thus provides a reduction of the distance dependence of the received light spot on the light receiver. The focal length preferably depends monotonically on the angle of incidence so that a stronger focal length acts on the remitted light beam with a steeper angle of incidence, that is at a smaller distance between the sensor and the object, or vice versa. The direction of increasing or decreasing focal length of this preferably monotonic relationship depends on the design of the sensor. Such a variable focal length can specifically correct the position of incidence by a greater or lesser deflection in accordance with the interference effect discussed above.

The optical metaelement can preferably have a prismatic effect that varies with the angle of incidence, in particular monotonically. The nanostructures of the optical metaelement are sensibly not described structurally, but rather functionally. In practice, it is not a question of which specific nanostructure is provided, but rather that the desired optical properties are achieved. There are also the most varied different implementation possibilities here, that is nanostructures that equally satisfy a desired optical effect. As discussed above, the angle of incidence corresponds to the object distance due to the spacing of the transmission path and reception path. A prismatic power that varies with the angle of incidence thus provides a reduction of the distance dependence of the received light spot on the light receiver. The prismatic power preferably depends monotonically on the angle of incidence so that a stronger prismatic power is exerted on the remitted light beam with a steeper angle of incidence, that is at a smaller distance between the sensor and the object, or vice versa. The direction of increasing or decreasing prismatic power of this preferably monotonic relationship depends on the design of the sensor. Such a variable prismatic power can specifically correct the position of incidence by a greater or lesser deflection in accordance with the interference effect discussed above.

The optical metaelement can preferably image the remitted light beam on the light receiver for all the angles of incidence occurring over a range of the sensor such that an overmodulation of the light receiver is avoided. A reception level of the light receiver particularly preferably remains within usual tolerances. The metaelement thus takes over a possible function of the optical corrective element. The design demand on the design of the nanostructures of the optical metaelement is here that an imaging of the remitted light beam in the light receiver plane is achieved for all the angles of incidence that correspond to the object distance such that an overmodulation of the light receiver is avoided. The distance dependence of the received light spot size in the light receiver plane is particularly preferably such that a reception level of the light receiver also remains substantially constant with a varying object distance. This can in particular be achieved with a focal length that depends on the angle of incidence. All the angles of incidence here means that angle range that corresponds to object distances in a measurement zone or within a range of the sensor.

The metaelement can preferably have a first part element for a reduction of the distance dependence of the received light spot position on a distance of the object and a second part element for an at least partial homogenization of a reception level at different distances of the object. The two effects discussed above under first and second of an optical corrective element are distributed over two part elements here. The first part element provides a reduction or elimination of the distance dependence of the received light spot position on the light receiver, the second part element provides a distance dependent focusing such that an overmodulation of the light receiver is avoided. The distance dependence of the received light spot size in the light receiver plane is particularly preferably such that a reception level of the light receiver also remains substantially constant with a varying object distance. Tine part elements are arranged behind one another in the light beam direction and can be arranged on oppositely disposed sides of a common substrate. An advantage of the arrangement of the part elements on a substrate is the inherently present precision of the alignment of the optical boundary surfaces that can be achieved only with a lot of effort in the adjustment or positioning with separate optical components.

The metaelement can preferably have a first part element for imaging light beams remitted from the far zone of the sensor on the light receiver and a second part element for imaging light beams remitted from the near zone of the sensor on the light receiver. The part zones can here be dimensioned such that the first part element has a larger aperture than the second part element. More light remitted by the object from the far zone can thus reach the light receiver than from the near zone so that an overmodulation of the light receiver by light remitted by objects in the near zone can be counteracted. Such a design of the metaelement can therefore contribute to a homogenization of the reception level over the reception range of the sensor.

The optical metaelement can preferably at least partly have the function of both the reception optics and the optical corrective element. The optical metaelement thus generates the reception light spot on the light receiver in the function of the reception optics and simultaneously provides an optical correction to relieve at least one of the above-named interference effects. The term at least partly here also has the double sense that the reception optics and/or the optical corrective element can have further optical elements and that the optical metaelement can cover even more functions. The optical metaelement is particularly preferably a reception optics and an optical corrective element in one; there are then no further optical elements in the reception path.

The optical metaelement can preferably be configured such that only light having one or more specified wavelengths or wavelength ranges is imaged on the light receiver. The optical metaelement then acts as an optical filter, for example a line filter or a bandpass filter. An extraneous light input on the light receiver can thus be prevented and the sensitivity and robustness of the sensor can be increased.

The transmission optics can preferably have a second optical metaelement. In this embodiment, an optical metaelement that replaces or supplements a, for example, refractive conventional transmission optics, is also provided in the transmission path. The function of the transmission optics is the generation of a delineated light beam, for example by collimation. Alternatively to an embodiment with a second optical metaelement, the transmission path can have a refractive transmission lens or the like. The first optical metaelement and the second optical metaelement are particularly preferably configured as a common metaelement. The common metaelement can then represent the total optics and can simultaneously act as a transmission optics, a reception optics, and an optical corrective element. Alternatively, supplementary additional optical elements are conceivable.

The sensor can preferably be formed as a distance measurement system in accordance with the time of flight principle or also as a simple light barrier.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

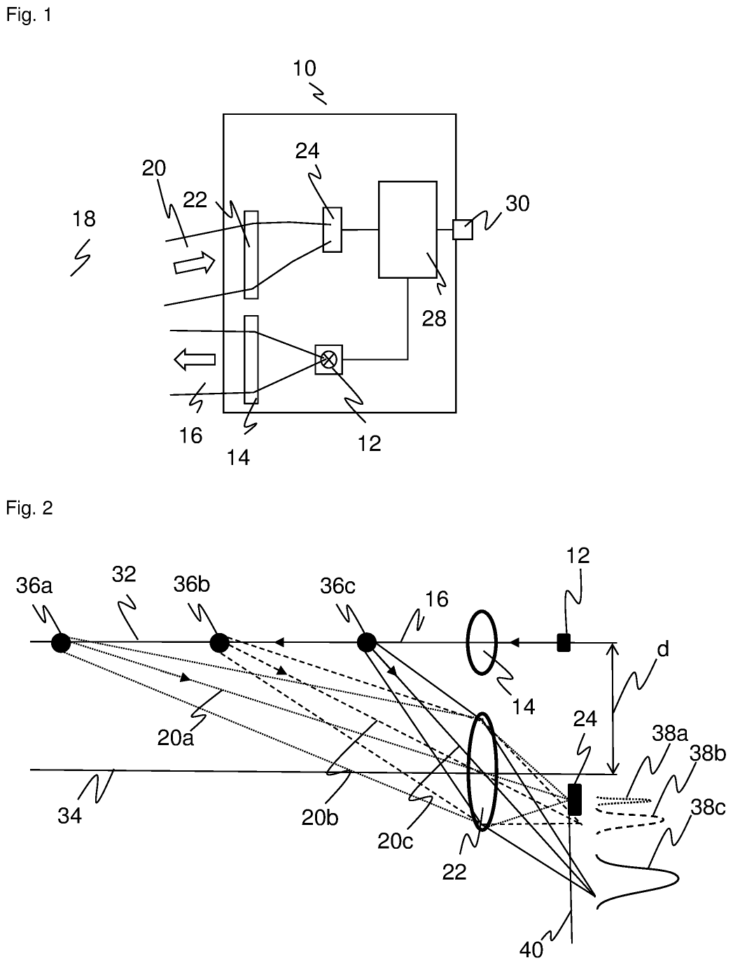

FIG. 1 a block diagram of an optoelectronic sensor;

FIG. 2 a schematic diagram to explain the distance dependence on the received light spot position and size in an optoelectronic sensor having pupil division;

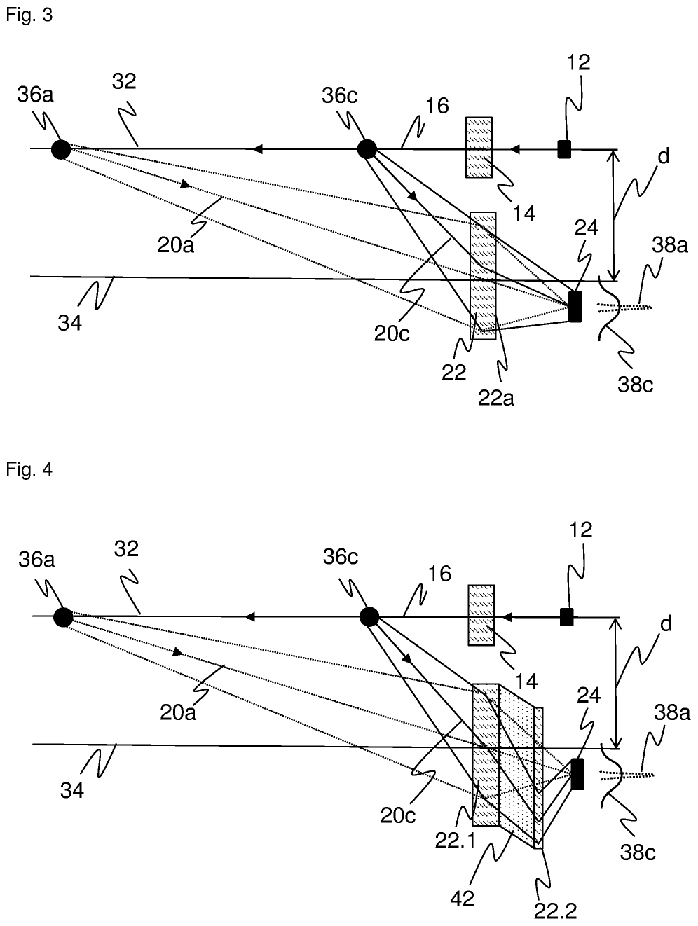

FIG. 3 a schematic representation of the transmission and reception paths of an optical sensor in accordance with the invention with an optical metaelement;

FIG. 4 a schematic representation of the transmission and reception paths of an optical sensor in accordance with the invention with two part elements an optical metaelement arranged behind one another in the light beam direction; and

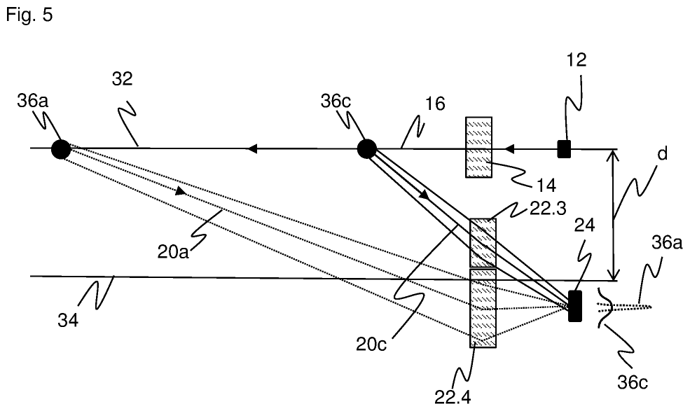

FIG. 5 a schematic representation of the transmission and reception paths of an optical sensor in accordance with the invention with two part elements of an optical metaelement arranged next to one another in the light beam direction.

FIG. 1 shows a schematic sectional representation of an optoelectronic sensor 10 having pupil division. A light transmitter 12 transmits a light beam 16 into a monitored zone 18 via a beam-shaping transmission optics 14. If the light beam 16 is incident onto an object in the monitored zone 18, a portion thereof moves back to the sensor 10 as a remitted light beam 20. The remitted light beam 20 is guided by a reception optics 22 onto a light receiver 24 that generates an electrical received signal therefrom. The transmission optics 14 and reception optics 22 are shown purely schematically as boxes to initially leave their specific structure open. In accordance with the invention, they are at least partly implemented by an optical metaelement, as will be explained later.

The position of incidence of the remitted light beam 20 or of the received light spot generated thereby on the light receiver 24 depends, due to the spacing d between the transmission optics 14 and the reception optics 22, on the distance of the scanned object at which the remitted light beam 20 is reflected back. The offset of the transmission optics 14 and the reception optics 22 can in particular have the result that the received light spot from a far object is registered on the light receiver 24 and that from a near object is not incident on the light receiver 24, as will be explained more exhaustively below. A control and evaluation unit 28 is connected to the light transmitter 12 and to the light receiver 24 to determine a presence and/or a distance of an object in the monitored zone 18, for example, from the electrical received signals.

The light receiver 24 in FIG. 1 can be a one-dimensional light receiver having a single light reception element, a receiver array having light reception elements or pixels arranged in a row or a matrix of light reception elements or pixels.

FIG. 2 shows a schematic diagram of the distance dependence on the received light spot position and size in an optoelectronic sensor having pupil division. For this purpose, the optical axis 32 at the transmission side and the optical axis 34 at the reception side are additionally drawn. The transmission optics 14 and the reception optics 22 are here initially still shown as refractive lenses to illustrate different distance-dependent interference effects that are then improved in accordance with the invention by the already addressed optical metaelement still to be explained in more detail.

The system sensitivity of an optoelectronic sensor 10 having pupil division initially depends on various properties of the sensor 10 itself such as the light transmitter 14, focal lengths of the transmission optics 14 and reception optics 22 or on the distance d between the light transmitter 14 and the light receiver 24. It furthermore varies with the distance of the respective object. An object is shown at three different distances by way of example in FIG. 2, an object 36a in a far zone, an object 36b in an intermediate zone, and an object 36c in a near zone. What this means in absolute distances can differ greatly and is determined by the design of the sensor 10 and the distance measurement zone to be covered or the range. The remitted light beam 20a of the object 36a in the far zone, the remitted light beam 20b of the object 36b in the intermediate zone, and the remitted light beam 20c of the object 36c in the near zone are incident on the light receiver 24 at respectively different positions or even miss it altogether as in the case of the light beam 20c that was remitted by the object 36c in the near zone. The position dependence or displacement results from the spacing d between the light transmitter 14 and the light receiver 24 and can be used for the distance determination in triangulation sensors. In the present case, however, this displacement has the result that the object 36c can no longer be detected by the light receiver 24 in the near zone since the received light spot is not incident on the light receiver 24 or its active surface. Restricted sensitivity can also occur in the intermediate zone if the received light spot is not incident on the light receiver 24 or its active surface.

Intensity profiles 38a, 38b, 38c of the received light spot are additionally shown along the displacement direction in a plane 40 defined by the light receiver 24.

The reception optics 22 is configured here such that with a far object 36a or with a remitted light beam 20a from infinity, a substantially sharp image is achieved on the light receiver 24. The received light spot for the object 36a in the far zone is accordingly diffraction limited and in particular almost punctiform. In accordance with the imaging equation 1/f=1/g+1/b, where f is the focal length, g the object width, and b the image distance, the images become blurred with a decreasing distance and the intensity profiles 38b, 38c of the received light spots become very large for the remitted light beam 20b from an object 36b from the intermediate zone or even the remitted light beam 20c from an object 36c from the near zone. In the intermediate and near zones, the intensity of the received light additionally increases, indicated schematically here by the larger surface area of the intensity profiles 38a, 38c in comparison with the intensity profile 38a, of the received light spot of the object 38a from the far zone.

FIG. 3 shows a schematic representation of the transmission and reception paths of an optical sensor in accordance with the invention having an optical metaelement 22 in the reception path that corrects the position of the received light spot. The optical metaelement 22 has the reference numeral of the reception optics of FIGS. 1 to 2 that it forms, replaces, or supplements in dependence on the embodiment. It preferably simultaneously satisfies said corrective functions. The optical metaelement or a further optical metaelement can equally form, replace or supplement the transmission optics 14 and is therefore provided with its reference numeral in its lower part. The design of the optical metaelement can be selected such that the light transmitter 12 and the light receiver 24 are arranged on a common expansion card.

The optical metaelement 22 has a metasurface 22a and is in particular structured as a metalens (flat optics). It is alternatively or additionally conceivable that the body or carrier of the optical metaelement 22 has a metamaterial, in particular that the optical metaelement 22 is a spaceplate.

Conventional optical components such as lenses, waveplates, or holograms are based on light propagation over distances that are much larger than the wavelength of the light beam 16 22 to shape wavefronts. In this way, substantial changes of the amplitude, phase, or polarization of light waves are gradually accumulated along the optical path. A metasurface 22a in contrast has structures that can be understood as miniature anisotropic light scatterers, waveguides or resonators, or optical antennas (arranged perpendicular). These structures have dimensions and distances in the nanometer range, much smaller than the wavelength of the light beam 16, 22. The metasurface 22a thereby shapes optical wavefronts in accordance with the Huygens principle into any desired shapes having sub-wavelength resolution in that the nanostructures introduce spatial variations in the optical response of the light scatterers. Effects of a conventional lens can thus be modeled, but also functionalities of other optical components such as beam splitters, polarizers, or diffraction grids. The special feature is the high flexibility of reaching a desired starting wavefront and thus the most varied optical effects through adapted nanostructures. Depending on the wavelength range, materials having a suitable transmission behavior are used, for example titanium dioxide, silicon nitride or gallium phosphide in the visible spectral range and aluminum nitride in the ultraviolet spectral range, and chalcogenide alloys in the medium and silicon in the longwave infrared range.

These considerations on a metasurface can be transferred to a metamaterial in which the interior or the carrier has corresponding nanostructures, with it being able to be combined with a metasurface. Spaceplates can thus in particular be implemented that effectively compress a light path on a smaller space for which purpose reference is again additionally made to the paper of Reshef et al. cited in the introduction. The optical metaelement 22 can consequently have a metastructure or nanostructure in the interior and/or on the front side and/or rear side.

The properties of the optical metaelement 22 are now preferably selected such that the focal length becomes a function of the angle of incidence. For this purpose, the metasurface 22a is correspondingly structured and/or a metamaterial is selected for the optical metaelement, is in particular configured as a spaceplate. The desired focal length dependence on the angle of incidence can be easily implemented with a spaceplate, for example by silicon layers or silicon oxide layers as an anisotropic element for focal length variation dependent on the angle of incidence.

The angle of incidence corresponds to the object distance, as previously shown. It may be a further design demand that an imaging in the receiver plane of the light receiver 24 takes place for all the object distances such that the light receiver is not overmodulated or the reception level is as constant as possible. The result in the embodiment shown is a varying received light spot size on the light receiver 24 in dependence on the object distance. The intensity of the light beam remitted by the object on the light receiver can thereby be set such that an overmodulation of the light receiver is avoided. In the embodiment, this means that the diameter of the received light spot is larger for light beams remitted from the near zone than for light beams remitted from the far zone.

FIG. 4 shows a schematic representation similar to FIG. 3 in which the optical metaelement 22 is divided into two part elements 22₁ and 22₂ arranged behind one another in the light beam direction. Both part elements can comprise metamaterial and/or a metasurface at the front side and/or rear side. The imaging and corrective functions can thus be distributed. In this example, the diameter of the received light spot is created by the first part element 22₁ and the position of the received light spot is created by the second part element 22₂ with a spatially resolved transmission function. The different functions of the optical metaelement 22, whether as a metamaterial and/or metasurface, in particular a focal length adjustment dependent on the angle of incidence, can be split over two or more part elements in this way or a comparable way. In this respect, functions can be separated and respectively assigned to a part element and/or the part elements can complement one another in satisfying the same function. The first part element 22₁ and the second part element 22₂ can, for example, be arranged on oppositely disposed sides of a common substrate 42. To simplify production processes, the substrate 42 can be built up with a typical thickness of 2 mm to 10 mm by adhering two or more layers onto one another. Alternatively, the metaelement 22 can also be formed as a surface structured volume body or as a surface structured plate.

FIG. 5 shows a schematic representation of the transmission and reception paths of a further embodiment of an optical sensor in accordance with the invention in which the optical metaelement 22 is divided into two part elements 22₃ and 22₄ arranged next to one another in the light beam direction. Both part elements can, as in the embodiments already shown, comprise metamaterial and/or a metasurface at the front side and/or rear side. In this example, the first part element 22₃ acts on light beams that were remitted by objects in the near zone; the second part element 22₄ acts on light beams that were remitted by objects in the far zone. The first part element 22₃ is advantageously arranged closer to the optical axis 32 at the transmission side than the second part element 22₄. This in particular avoids an external migration of the received light spot in the near zone and very steep angles of incidence of the light beam 20c on the light receiver 24. The intensity of the light remitted by the objects 36a, 36c arriving on the light receiver 24 can be influenced via the apertures of the part elements 22₃, 22₄. Since quadratically more light power is incident on the aperture the near zone corresponding to the smaller distance, said aperture can be selected as correspondingly smaller in the near zone than in the far zone so that the intensity is homogenized on the light receiver and thus the reception level.

1. An optoelectronic sensor for detecting an object in a monitored zone that has a light transmitter and a transmission optics associated with the light transmitter in a transmission path for transmitting a light beam and a light receiver and a reception optics associated with the light receiver and offset from the transmission optics by a spacing in a reception path for receiving a light beam remitted by the object and for generating a received light spot on the light receiver, as well as a control and evaluation unit that is configured to evaluate a received signal of the light receiver,
wherein the reception optics has at least one optical metaelement having a metasurface and/or a metamaterial and the reception optics is configured such that a displacement of the received light spot on the light receiver in a near zone of the sensor dependent on a distance of the object from the sensor is no larger than a full width at half maximum of the received light spot.

2. The sensor in accordance with claim 1, wherein the reception optics is configured such that the displacement of the received light spot on the light receiver in the near zone of the sensor dependent on the distance of the object from the sensor is no larger than a half full width at half maximum of the received light spot.

3. The sensor in accordance with claim 1, wherein the reception optics is configured such that the received light spot does not have any displacement dependent on the distance of the object from the sensor.

4. The sensor in accordance with claim 1, wherein the optical metaelement has at least one metalens.

5. The sensor in accordance with claim 1, wherein the optical metaelement has at least one spaceplate.

6. The sensor in accordance with claim 1, wherein the reception optics has at least one refractive and/or diffractive optics.

7. The sensor in accordance with claim 1, wherein the optical metaelement at least partly has the function of the reception optics.

8. The sensor in accordance with claim 1, wherein the sensor has an optical corrective element in the reception path that reduces a dependence of a reception level of the light receiver on the distance of the object from the sensor.

9. The sensor in accordance with claim 8, wherein the optical metaelement at least partly has the function of both the reception optics and the optical corrective element.

10. The sensor in accordance with claim 1, wherein the reception optics images the remitted light beam for all the angles of incidence occurring over a range of the sensor on the light receiver such that an overmodulation of the light receiver is avoided.

11. The sensor in accordance with claim 1, wherein the reception optics images the remitted light beam for all the angles of incidence occurring over a range of the sensor on the light receiver such that a reception level of the light receiver remains constant.

12. The sensor in accordance with claim 1, wherein the metaelement has a first part element for a reduction of a distance dependence of the received light spot position on a distance of the object and a second part element for an at least partial homogenization of a reception level at different distances of the object.

13. The sensor in accordance with claim 1, wherein the transmission optics has a second optical metaelement.

14. The sensor in accordance with claim 13, wherein the optical metaelement and the second optical metaelement are configured as a common metaelement.

15. The sensor in accordance with claim 1, wherein the sensor is configured as a light barrier or as a distance measurement sensor in accordance with the time of light principle.

16. A method of detecting an object in a monitored zone, wherein a light beam is transmitted by a light transmitter, a light beam remitted by the object is imaged on a light receiver by a reception optics arranged offset by a distance from the light transmitter, and a received signal is generated by the light receiver,
wherein the reception optics has at least one optical metaelement having a metasurface and/or a metamaterial and the reception optics is configured such that a displacement of the received light spot on the light receiver dependent on a distance of the object from the sensor is reduced such that the displacement in a near zone of the sensor is no larger than a full width at half maximum of the received light spot.
